(19) United States
(12) Patent Application Publication
(10) Pub. No.: US 2007/0019879 A1
(43) Pub. Date: Jan. 25, 2007

(54) Dequantization method and apparatus, and video decoding method and apparatus using the dequantization method

(75) Inventors: Woo-Jin Han, Suwon-si (KR); Kyo-hyuk Lee, Seoul (KR); Sang-chang Cha, Hwaseong-si (KR); Bae-keun Lee, Bucheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/487,986

(22) Filed: Jul. 18, 2006

Related U.S. Application Data
(60) Provisional application No. 60/700,337, filed on Jul. 19, 2005.
(60) Provisional application No. 60/703,004, filed on Jul. 28, 2005.

(30) Foreign Application Priority Data
Oct. 27, 2005 (KR) 10-2005-0101961

(51) Int. Cl. G06K 9/00

(52) U.S. Cl. 382/251; 382/168

(57) ABSTRACT

A dequantization method and an apparatus in which restored values for original values are obtained by dequantizing quantization level values generated when the original values are quantized. The dequantization method includes updating a histogram by accumulating histogram counts for the quantization level values, estimating a distribution function of the original values based on the histogram, and obtaining the restored values for the quantization level values from the distribution function.

### CROSS-REFERENCE TO RELATED APPLICATIONS

This application claims priority from Korean Patent Application No. 10-2005-0101961, filed on Oct. 27, 2005 in the Korean Intellectual Property Office, and U.S. Provisional Patent Application Nos. 60/700,337 and 60/703,004 filed on Jul. 19, 2005 and Jul. 28, 2005, respectively, the disclosures of which are incorporated herein by reference in their entireties.

### BACKGROUND OF THE INVENTION

1. Field of the Invention

Apparatuses and methods consistent with the present invention relate to video coding, and more particularly, to increasing a video coding efficiency by improving at least one of a quantization process and dequantization process in a video coding process.

2. Description of the Related Art

With the development of information and communication technologies including the Internet, multimedia communications are increasing in addition to text and voice communications. The existing text-centered communication systems are insufficient to satisfy consumers' diverse desires, and thus multimedia services that can accommodate diverse forms of information such as text, image, music, and others are increasing. Since multimedia data is large, mass storage media and wide bandwidths are required for storing and transmitting the multimedia data. As such, compression coding techniques are required to transmit the multimedia data.

A basic principle of data compression is to remove data redundancy. Data can be compressed by removing spatial redundancy, such as a repetition of the same color or object in images, temporal redundancy, such as similar adjacent frames in moving images or continuous repetition of sounds, and visual/perceptual redundancy, which considers human insensitivity to high frequencies. In a general video coding method, the temporal redundancy is removed by temporal filtering based on motion compensation, and the spatial redundancy is removed by a spatial transform.

Coefficients generated through a temporal prediction process and a spatial prediction process must be properly lossy-compressed according to the size of a target bitstream. This lossy compression is performed by a quantization process. Most standard image and video codecs based on the lossy compression, such as Joint Photographic Experts Group (JPEG) or Moving Picture experts Group (MPEG), perform a quantization process and a dequantization process according to quantization steps. That is, if a value is input to a quantization module, it divides the input value into quantization steps, and then creates integer quantization steps to obtain quantization levels.

In most standards, an index of compression quality, which is called a quantization parameter (QP), is used. As the index value becomes smaller, the corresponding quantization step value becomes larger, and this causes the amount of information to be greatly reduced. For example, in the case of digital video codec standard H.264, the QP has 52 values in the range of 0 to 51. A mapping table mapping QP values to quantization steps is generally used.

For example, if it is assumed that an input value before quantization, i.e., the original value, is x and the quantization step is Qs, a quantization level value L can be expressed by Equation (1).

$$L = ⌊ \frac{x}{Qs} + f ⌋ \qquad ( 1 )$$

In Equation (1), f denotes an offset value, and may have a value in the range of 0 to 1. If the value f is ½, the quantization level value L has a round-off value of an original value x/Qs. If the value f is less than ½, the quantization level value L has a result similar to the case in which x/Qs is rounded down, whereas if the value f is greater than ½, the quantization level L has a result similar to the case in which x/Qs is rounded up.

In the case of video coding, it is generally known that the distribution of coefficients to be quantized conforms to the Laplacian distribution. The normalized Laplacian distribution if symmetrical about zero, and as the value becomes larger, the frequency thereof decreases gradually. Since it is more efficient to compress a value proximate to zero in a lossless compression method such as variable length coding, a value that makes an operation result proximate to a round-down value is generally used as the value f.

For example, in the case of quantizing an inter-prediction residual in H.264, the value f is defined as Qs/6, while in the case of quantizing an intra-prediction residual, the value f is defined as Qs/3.

A decoder receives the quantization level value L, and restores the value x from the received quantization level value L. The restored value of x is x′, and is represented by Equation (2).
x′=L·Qs (2)

FIG. 1 is a view explaining the comparison of a quantization level value L for an original input value x with a restored value x′. The original input value x is a certain real number on a number line A, and the discrete quantization level value L for each real number value is determined by an offset value f and a quantization step Qs. A discrete section having the same quantization level value L on the number line A is referred to as a “level section.” Accordingly, if the difference between two input values, which are somewhat different, is within the same level section, the quantization level values L of the two input values are the same.

It can be seen from FIG. 1 that since the offset value is ½, the level section in which the quantization level value L is zero is widest. The value x′, restored by the dequantization, is calculated by simply multiplying the quantization level value L by Qs, without taking the offset value into account.

The related art quantization and dequantization process is performed under the assumption of a Laplacian distribution. In particular, the offset value f is predetermined in consideration of the statistical characteristics of the inter-prediction residual and the intra-prediction residual. However, an actual image is not properly presented through one distribution. Accordingly, if the distribution which can best represent the current coefficients can be accurately known, it is possible to further increase the compression efficiency. In particular, if the restored value x′ for the value x can be restored as a value statistically closest to the input value x, the picture quality of the restored video frame can be improved. However, there is a problem in that the decoder does not know the input value x.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides apparatuses and methods to improve the picture quality of a video frame being restored through a decoder by estimating restored coefficient values more accurately using statistical distribution of quantization level values.

According to an aspect of the invention, there is provided a dequantization method of obtaining restored values for original values by dequantizing quantization level values generated when the original values are quantized, which includes updating a histogram by accumulating histogram counts for the quantization level values; estimating a distribution function of the original values based on the histogram; and obtaining the restored values for the quantization level values from the distribution function.

According to another aspect of the present invention, there is provided a dequantization apparatus for obtaining restored values for original values by dequantizing quantization level values generated when the original values are quantized, which includes means for updating a histogram by accumulating histogram counts for the quantization level values; means for estimating a distribution function of the original values based on the histogram; and means for obtaining the restored values for the quantization level values from the distribution function.

In still another aspect of the present invention, there is provided a video decoding method, which includes performing lossless decoding on an input bitstream, and extracting texture data and motion vectors from the decoded bitstream; estimating a distribution function based on a histogram updated by quantization level values constituting the extracted texture data, and obtaining restored values for the quantization level values from the estimated distribution function; restoring a residual frame by performing an inverse spatial transform on the restored values; generating a predicted frame by performing motion compensation on a pre-restored reference frame using the motion vectors; and restoring a current frame by adding the restored residual frame to the predicted frame.

In yet still another aspect of the present invention, there is provided a video decoder, which includes an entropy decoding unit performing lossless decoding on an input bitstream and extracting texture data and motion vectors from the decoded bitstream; a dequantization unit estimating a distribution function based on a histogram updated by quantization level values constituting the extracted texture data, and obtaining restored values or the quantization level values from the estimated distribution function; an inverse spatial transform unit restoring a residual frame by performing inverse spatial transform on the restored values; a motion compensating unit generating a predicted frame by performing motion compensation on a pre-restored reference frame using the motion vectors; and an adder restoring a current frame by adding the restored residual frame to the prediction frame.

### BRIEF DESCRIPTION OF THE DRAWINGS

The above and other aspects of the present invention will become more apparent from the following detailed description of exemplary embodiments taken in conjunction with the accompanying drawings, in which:

FIG. 1 is a view explaining the comparison of a quantization level value L for an original input value x with a restored value x′;

FIG. 2 is a view illustrating a histogram according to an exemplary embodiment of the present invention;

FIG. 3 is a view explaining an example of obtaining a restored value x′ by interpolating a discrete function Fc(L);

FIG. 4 is a view explaining the concept of obtaining Lo from a function value of a boundary position;

FIG. 5 is a view explaining an example of obtaining a restored value x′ for a level section in which a quantization level is zero;

FIG. 6 is a view explaining the case in which an attenuation value β is applied to a histogram;

FIG. 7 is a view illustrating the case in which alternating current (AC) and direct current (DC) components of a discrete cosine transform (DCT) coefficient are independent of each other;

FIG. 8 is a block diagram illustrating the construction of a dequantization apparatus according to an exemplary embodiment of the present invention; and

FIG. 9 is a block diagram illustrating the construction of a video decoder having the dequantization unit of FIG. 8 according to an exemplary embodiment of the present invention.

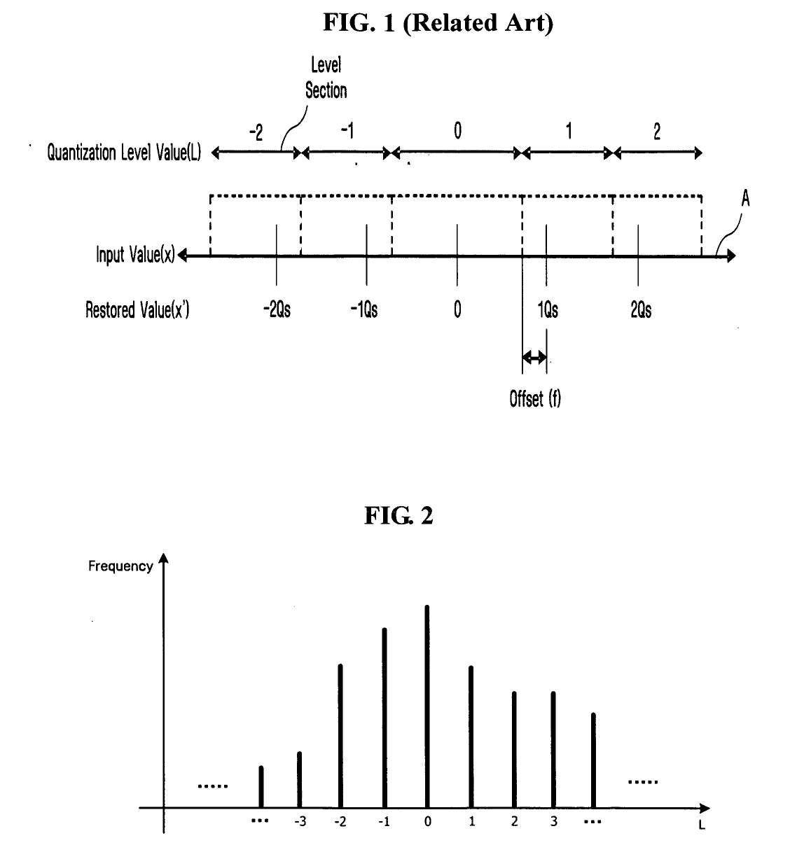

### DETAILED DESCRIPTION OF EXEMPLARY EMBODIMENTS OF THE INVENTION

Hereinafter, exemplary embodiments of the present invention will be described in detail with reference to the accompanying drawings. The aspects and features of the present invention and methods for achieving the aspects and features will be apparent by referring to the embodiments to be described in detail with reference to the accompanying drawings. However, the present invention is not limited to the embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used for the same elements across various figures.

A distribution based dequantization technique proposed according to an exemplary embodiment of the present invention may be applied to any technical field in which quantized values are restored using a quantization technique. Accordingly, although the exemplary embodiments of the present invention are herein described on the basis of video coding, it is to be noted that the present invention may be applied to image coding, audio coding, and any type of coding using lossy compression.

On the assumption that a distribution function for x/Qs (x is a coefficient before being quantized in an encoder) corresponding to a quantization level L in a specified level section [a, b) is defined as F(t), an optimum L (hereinafter referred to as “Lo”) may be regarded as an average of the distribution function F(t) in the section [a, b). By multiplying the obtained Lo by Qs, a resultant value x′ can be calculated.

Since Lo is a value that divides an area occupied by the distribution function F(t) in the section [a, b), Lo can be expressed by Equation (3).

$${\int }_{t = a}^{Lo} F ( t ) ⅆ t = \frac{1}{2} {\int }_{t = a}^{b} F ( t ) ⅆ t \qquad ( 3 )$$

Using Equation (3), it is possible to restore x′ to be more proximate to the actual input value x in consideration of the distribution function F(t). In the related art, x′ is restored by L*Qs, that is, (a+f)Qs, for x>0, and (b−f)Qs, for x<0. By contrast, according to the present invention, a value of x′ that is more proximate to the value x can be obtained in consideration of the distribution function, and as a result, the coding efficiency can be increased.

However, there exists a problem in that the distribution function F(t) is known in an encoder, but it cannot be known in a decoder until additional information is provided. Since the information available in the decoder is the quantization step Qs and the quantization level value L, the present invention proposes a technique of estimating the distribution function F(t) using the information available in the decoder and calculating the optimum value x′ from the distribution function.

In order to obtain the distribution function F(t) for the input value, the decoder utilizes a statistical value of the quantization level value L, and more particularly, a histogram. If a certain quantization level value L is input, the histogram is updated by increasing a counter of a bucket corresponding to each L one by one.

FIG. 2 shows a histogram according to an exemplary embodiment of the present invention, in which the frequency accumulated for each quantization level value L is illustrated. The histogram is updated in such a way that the corresponding frequency is increased one by one whenever a new quantization level value L is input.

If it is assumed that a discrete function represented by such a histogram is F_{c}(L), the discrete function F_{c}(L) is quite similar to the distribution function F(t) for the input value x in the actual encoder. This is because there is a strong probability that coefficients in the same video sequence, the same frame, or the same slice will have a similar statistical characteristic.

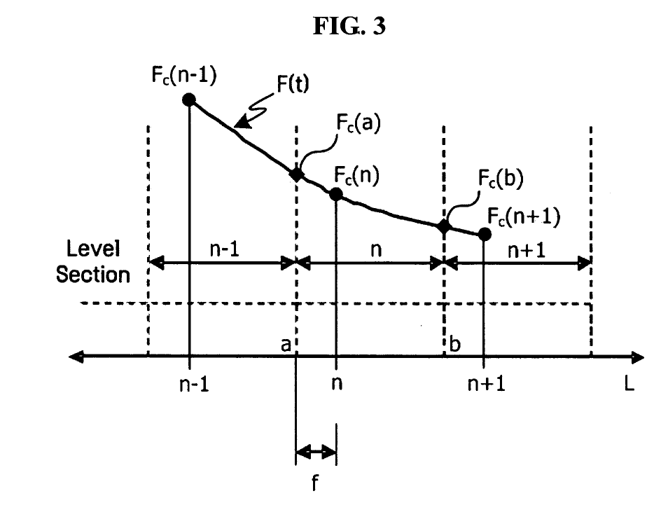

FIG. 3 is a view explaining an example of obtaining the resultant output value x′ by interpolating the discrete function F_{c}(L). A continuous distribution function F(t) can be obtained by interpolating the discrete function F_{c}(L) obtained from the histogram. A linear interpolation (meaning, for example, that histogram counts are connected by a straight line), bi-linear interpolation, bi-cubic interpolation, and others, may be used as the interpolation method. If the distribution function F(t) is obtained, the output value x′ can be calculated using Equation (3).

Since the interpolation must be performed whenever a new quantization level value (i.e., information on one pixel) is input to change the histogram, it is not realistic to use this process. Accordingly, it is required to provide a technique of simply calculating the value x′ by using the discrete function as it is, rather than by interpolating the discrete function with the distribution function.

It is assumed that the discrete function F_{c}(L) has been obtained through the histogram analysis, the quantization level is n, and the range of the level section is [a, b), as shown in FIG. 3. Then, it is possible to estimate counts (which means a function value on the basis of the interpolated distribution function) of a boundary position at [a, b), i.e., F_{c}(a) and F_{c}(b), by using a histogram count F_{c}(n) and histogram counts F_{c}(n−1) and F_{c}(n+1) of neighboring quantization levels. Here, b is equal to a+1.

In this case, considering a distance relation between boundary positions, Fc(a) and Fc(b) can be expressed by Equation (4). Here, α can be set as an offset value f.
F_{c}(a)=F_{c}(n−1)×α+F_{c}(n)×(1−α)
F_{c}(b)=F_{c}(n)×α+F_{c}(n+1)×(1−α) (4)

In order to reduce the complexity of the calculation, α may be simply set to ½. In this case, Fc(a) and Fc(b) are expressed by Equation (5).

$${F}_{c} ( a ) = \frac{{F}_{c} ( n - 1 ) + {F}_{c} ( n )}{2} \\ {F}_{c} ( b ) = \frac{{F}_{c} ( n ) + {F}_{c} ( n + 1 )}{2} \qquad ( 5 )$$

After Fc(a) and Fc(b) have been obtained, Lo can be calculated by a diverse interpolation method including linear interpolation. Using the linear interpolation, Lo can be calculated by representing F(t) as a straight line or diverse curves connecting Fc(a) to Fc(b) and halving the area formed by F(t) in the section (a, b). In order to calculate the value x′ halving the area, a quadratic equation must be solved even if the simplest linear interpolation is used, and this requires a large amount of computation. Accordingly, the present invention proposes a new method simpler than the above-described linear interpolation.

It is assumed that weight values of Fc(a) and Fc(b), which contribute to the current quantization range, are w1 and w2. In this case, current level sections are represented by two squares each having heights of w1×Fc(a) and w2×Fc(b), and then Lo, which halves each area of two squares, is searched for. The weight values w1 and w2 may be simply set to 1, or may be set to different values. For example, the weight values w₁ and w₂ may be determined in consideration of the value L belonging to the section (a, b), i.e., the distance between n and the boundary positions a and b. In this case, w₁ will be 1−f, and w₁ will be f.

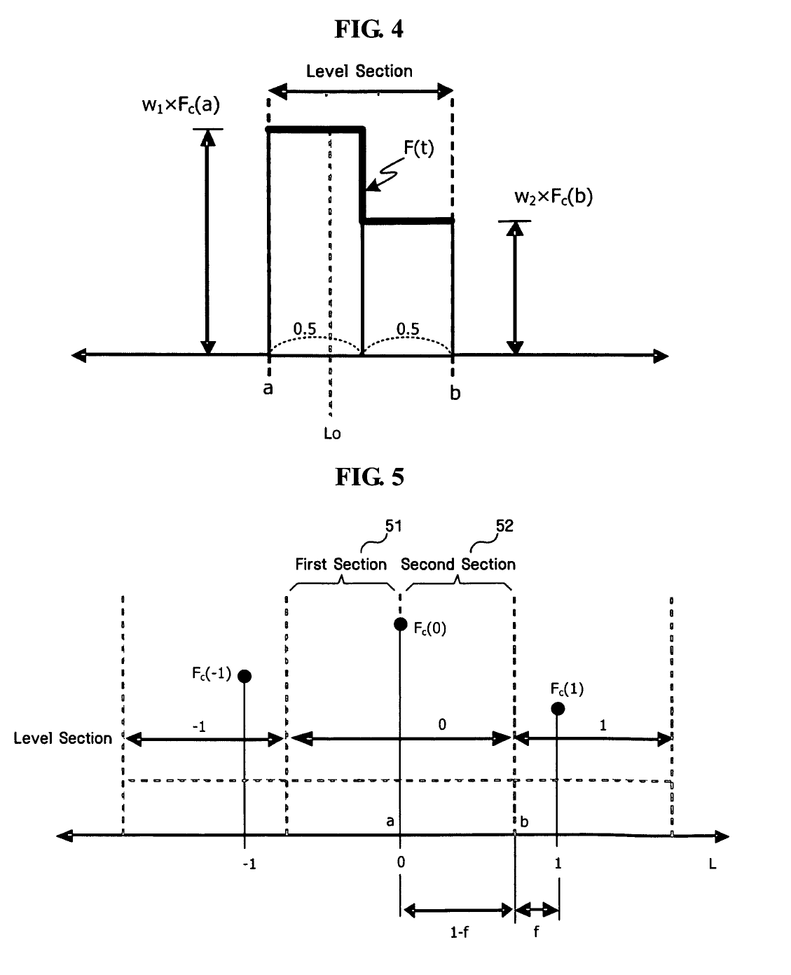

FIG. 4 is a view explaining the concept of expressing the distribution function F(t) by using the determined w₁F_{c}(a) and w₂F_{c}(b) and obtaining Lo from the distribution function. In the embodiment as shown in FIG. 4, the distribution function F(t) can be expressed as two contiguous bar graphs having the same width, for example, 0.5, and heights of w₁F_{c}(a) and w₂F_{c}(b) in the level section. In this case, Lo is obtained by selecting a point on an axis of abscissas which halves the distribution function F(t). If w₁F_{c}(a)>w₂F_{c}(b), Lo is contained in a left rectangular area, whereas if w₁F_{c}(a)<w₂F_{c}(b), Lo is contained in a right rectangular area.

Since value x′ is calculated from Lo*Qs, the value x′ may be expressed as Equation (6) by organizing the above items.

$$\begin{matrix}{x}^{′} = \{ a + \frac{{w}_{1} {F}_{c} ( a ) + {w}_{2} {F}_{c} ( b )}{4 {w}_{1} {F}_{c} ( a )} \} {Q}_{S} & if {w}_{1} {F}_{c} ( a ) > {w}_{1} {F}_{c} ( b ) \\ {x}^{′} = \{ a + \frac{3 {w}_{2} {F}_{c} ( b ) - {w}_{1} {F}_{c} ( a )}{4 {w}_{2} {F}_{c} ( b )} \} {Q}_{S} & otherwise\end{matrix} \qquad ( 6 )$$

If L is zero, the corresponding level section is different from other level sections, and thus it is difficult to utilize Equation (6) as it is. Referring to FIG. 5, the level section in which L is zero may be divided into a first left section 51 and a second right section 52 on the basis of its origin (L=0).

In consideration of the second section 52, the function value Fc(b) of the right boundary may be determined by the second equation of Equation (4) or the second equation of Equation (5), like other level sections. In this case, Fc(0) can be used as the function value F_{c}(a) of the left boundary, without the necessity of performing additional interpolation.

If the boundary value for the second section 52 has been determined, the restored value x′ can be determined by Equation 7, considering that the length of the section is shortened to 1−f.

$$\begin{matrix}{x}^{′} = \{ a + 2 ( 1 - f ) \frac{{w}_{1} {F}_{c} ( a ) + {w}_{2} {F}_{c} ( b )}{4 {w}_{1} {F}_{c} ( a )} \} {Q}_{S} & if {w}_{1} {F}_{c} ( a ) > {w}_{2} {F}_{c} ( b ) \\ {x}^{′} = \{ a + 2 ( 1 - f ) \frac{3 {w}_{2} {F}_{c} ( b ) - {w}_{1} {F}_{c} ( a )}{4 {w}_{2} {F}_{c} ( b )} \} {Q}_{S} & otherwise\end{matrix} \qquad ( 7 )$$

Similarly, the function value of the left boundary in the first section 51 can be determined by the first equation of Equation (4) or the first equation of Equation (5), and Fc(0) can be used as the function value of the right boundary. After the boundary value for the first section 51 is determined, the restored value x′ can be determined by Equation 7, in the same manner as the second section 52.

If it is assumed that the level section in which L=0 is [−0.5, 0.5) in order to make the length of the level section in which L=0 coincide with other level sections, it is not necessary to divide the level section into two sections as shown in FIG. 5. In this case, since the left boundary a is −0.5 and the length of the level section is 1, Equation (6) can be used as it is in the same manner as other level sections. In this case, F_{c}(a) will be determined by F_{c}(−1) and F_{c}(0) and F_{c}(b) will be determined by F_{c}(0) and F_{c}(1).

As described above, the value x′ is not restored by multiplying the quantization level by the quantization step, but is restored by reflecting the distribution of the quantization levels, and thus the difference between the restored value x′ and the original input value x can be reduced. As such, the present invention may be used to estimate the distribution of the input value x, based on the histogram, using the information obtainable in the decoder, without additional bit transmission from the encoder, and to obtain the optimum value x′ according to the estimated distribution.

The statistical methods such as used in the present invention can produce good results when several samples are used to obtain the statistical values. Accordingly, the histogram counts should be accumulated using all the processed quantization levels, but samples which are spatially or temporally adjacent to each other generally have robust relevancy depending on the characteristic of an actual image/audio/video sequence. If a predetermined number of samples are accumulated, it may be desireable to reduce the weight value of the previous statistical value by multiplying the accumulated histogram count by an attenuation value and then to reuse the method of accumulating the counts. That is, if the maximum accumulated value is set to N, the accumulative counting of input quantization levels is performed (which refers to the simple counting of the number of input L values, and is discriminated from the histogram count for accumulating the counts for each L). If the accumulated count value exceeds N, it is reduced by multiplying the histogram count, i.e., the value F_{c}(L), by an attenuation value β. Accordingly, the value of β that is smaller than 1 is used.

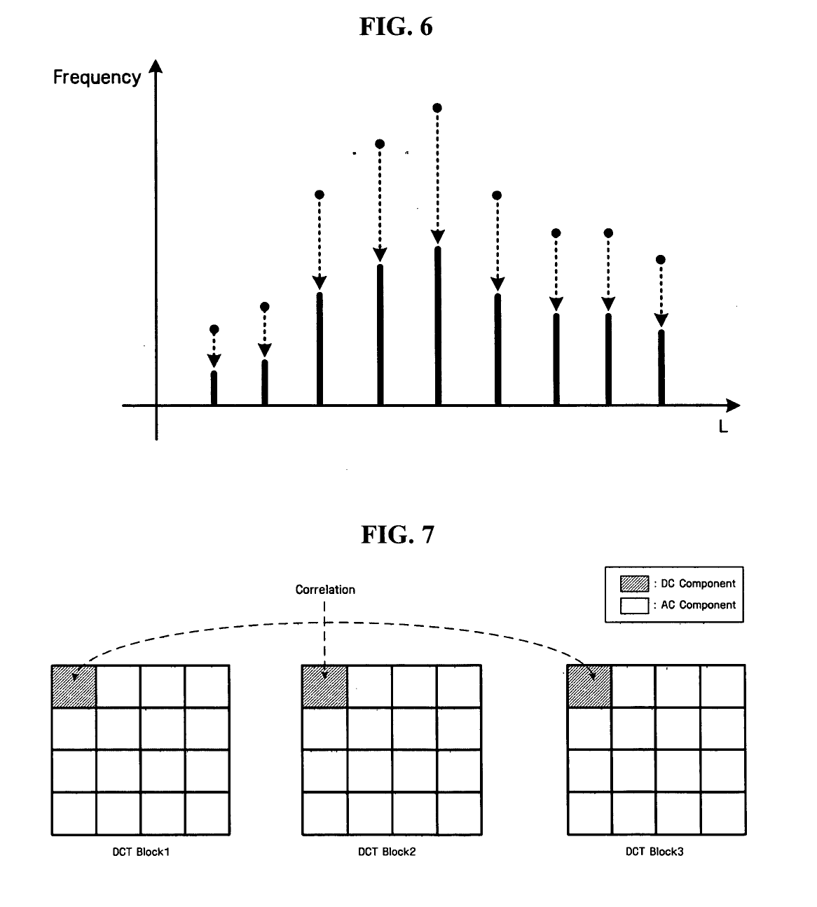

If it is assumed that points indicated in the histogram of FIG. 6 are original histogram counts, and a new L is input to reach the maximum accumulated value N, the original histogram counts are reduced in the rate of β. Accordingly, a high weight value is given to the newly input L.

If it is assumed that the maximum accumulated value N corresponds to the number of samples belonging to one frame, the weight value may be differently given to L in the unit of a frame. If it is assumed that N corresponds to the number of samples belonging to one slice, the weight value may be differently given to L in the unit of a slice. N may be set to any value in consideration of the property of the input data.

Further, if the coefficients subject to quantization/dequantization are DCT coefficients, it should be considered that a DC component and an AC component of each DCT coefficient have somewhat different statistical characteristics. FIG. 7 is a view illustrating the above characteristics.

In FIG. 7, the DC component contained in each DCT block is hardly related to the AC component around the corresponding DCT block, but is closely related to the DC component contained in another DCT block. Accordingly, it is desireable that different histograms are generated and applied to the coefficient of the DC component and the coefficient of the AC component, respectively. Of course, different maximum accumulated values N may be provided to the histogram of the DC component and the histogram of the AC component, respectively.

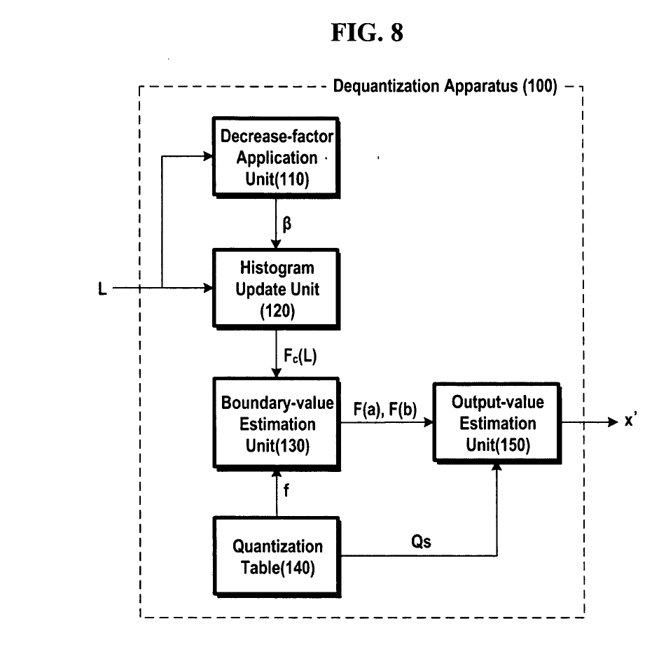

FIG. 8 is a block diagram illustrating a dequantization apparatus 100 according to an exemplary embodiment of the present invention. The dequantization apparatus includes a decrease-factor application unit 110, a histogram update unit 120, a boundary-value estimation unit 130, a quantization table 140, and an output-value estimation unit 150.

If one quantization level value L is input, the histogram update unit 120 increases the histogram count corresponding to the interested quantization level value by one. The histogram update unit 120 accumulates the quantization level value to be input to store the histogram count F_{c}(L) for each quantization level as shown in FIG. 2.

The decrease-factor application unit 110 accumulates the input quantization level values L and determines whether the accumulated count exceeds the maximum accumulated value N. If the accumulated count is larger than the maximum accumulated value N, the decrease-factor application unit 110 provides the histogram update unit 120 with the attenuation value β. If the accumulated count is equal to the attenuation value β, the count is initialized to zero. N may be any one of the number of frame samples, the number of slice samples, the number of macroblock samples, and other values. Of course, the attenuation value β may be zero. In this case, the previously accumulated histogram count is removed (i.e., initialized), and the histogram is prepared only by a newly input value.

If the histogram update unit 120 receives the attenuation value β from the decrease-factor application unit 110, the histogram update unit 120 updates the histogram counts F_{c}(L) for all quantization levels as values multiplied by the attenuation value β, respectively.

The quantization table 140 is a table in which quantization steps Qs and offset values f are predefined by conditions, and the same tables are used in the encoder and the decoder. The offset value f is provided to the boundary-value estimation unit 130, and the quantization step Qs is provided to the output-value estimation unit 150.

The boundary-value estimation unit 130 estimates the boundary position counts F_{c}(a) and F_{c}(b) of each level section by use of the histogram count F_{c}(L) provided from the histogram update unit 120. The level section cannot be determined only by the value L initially input, and consequently, the offset value f provided from the quantization table 140 is required to determine the level section. For example, since the left boundary a of the level section in which L is n is indicated by n−f, and the right boundary b is indicated by n+1−f, the offset value f should be known to determine the level section.

Although the boundary-value estimation unit 130 may adopt diverse methods for estimating the boundary position counts F_{c}(a) and F_{c}(b), the present invention may adopt a method in Equation (4) or Equation (5) as an example. Although the method for obtaining the boundary position counts may be somewhat changed, as compared with other level sections, a level section in which the quantization level is zero has been described as above, and as such, a duplicate explanation thereof will be omitted.

The output-value estimation unit 150 calculates the final restored value x′ by use of the estimated boundary position counts F_{c}(a) and F_{c}(b). For this, Lo is firstly determined in each level section, and then determined Lo is multiplied by Qs, which can restore the value x′. Of course, the value x′ can be obtained by calculation once, without carrying out an intermediate process for obtaining Lo.

Diverse known interpolation methods, such as linear interpolation, spline interpolation, and others, may be adopted as the method of calculating the value x′ from the estimated boundary position counts F_{c}(a) and F_{c}(b). In order to reduce the calculation amount during the dequantization, however, the value x′ can be calculated by the simple operation such as Equation (6). Of course, in the case of the level section in which the quantization level is zero, the value x′ may be obtained by Equation (7), or may be obtained by Equation (6) under the assumption that the level section is (−0.5, 0.5).

If L is the quantization level value of the DCT coefficient, it is desireable that the above process is performed with respect to the AC component of the DCT coefficient and the DC component of the DCT coefficient.

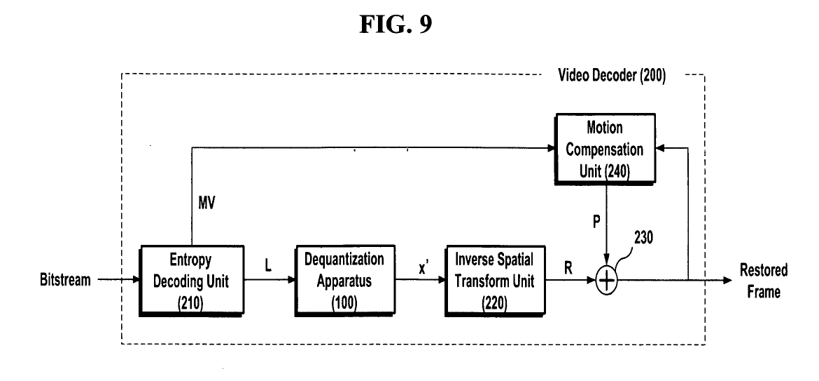

FIG. 9 is a block diagram illustrating the construction of a video decoder 200 having a dequantization unit according to an exemplary embodiment of the present invention.

First, the bitstream coded by the encoder is input to an entropy decoding unit 210. The entropy decoding unit 210 performs lossy decoding of the bitstream to extract texture data and motion data from the bitstream. The lossy decoding process is performed in the reverse process to the lossless coding process performed by the encoder. Huffmann coding, arithmetic coding, or variable length coding, for example, may be used as an lossless coding/decoding algorithm.

The texture data includes quantized data; that is, quantized level values L, and the motion data includes motion vectors MV, macroblock pattern, and others.

The dequantization apparatus 100 dequantizes the extracted texture data using an exemplary method proposed according to the present invention. More specifically, the distribution function is estimated on the basis of the histogram updated by the quantization level value constituting the extracted texture data, and the restored value for the quantization level value is evaluated from the estimated distribution function.

An inverse spatial transform unit 220 performs an inverse spatial transform of the restored coefficients. The inverse spatial transform is performed in a mode corresponding to the spatial transform performed in the encoder. Specifically, an inverse DCT transform or an inverse wavelet transform may be used. As the result of the inverse spatial transform, a residual frame R is restored.

A motion compensation unit 240 generates a predicted frame P by performing motion compensation on the reference frame previously restored using the motion vector MV provided from the entropy decoding unit 210.

An adder 230 restores the current frame by adding the restored residual frame R to the prediction frame P.

Although the dequantization unit 100 shown in FIG. 9 is applied to a video decoder, it will be apparent to those skilled in the art that the unit may be applied to image coding, audio coding, or any other coding adopting the lossy compression.

Several exemplary logic blocks described and shown in the embodiments of FIGS. 8 and 9 may be implemented by a universal processor designed to perform the functions described herein, a digital signal processor (DSP), an application-specific integrated circuit, a field programmable gate array (FPGA) or other programmable logic units, a discrete gate or a transistor logic unit, discrete hardware components, or the combination thereof. The universal processor is a microprocessor, but alternatively, may be any conventional processor, controller, microprocessor or state machine. The processor also may be implemented by a combination of computing devices (e.g., a combination of a DSP and a microprocessor), a plurality of microprocessors, at least one microprocessor related to a DSP core, or other constituents.

As described above, according to the present invention, a value that is much closer to the input value prior to the quantization process may be restored without additionally increasing the bit rate, by improving the dequantization process using quantization steps.

In particular, in the case where the present invention is applied to a video decoder, the picture quality of a video can be improved.

Although exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A dequantization method of obtaining restored values for original values, the dequantization method comprising:
updating a histogram by accumulating histogram counts for quantization level values;
estimating a distribution function of the original values based on the histogram; and
obtaining the restored values for the quantization level values from the distribution function.

2. The method of claim 1, wherein the quantization levels are generated when the original values are quantized.

3. The method of claim 1, wherein the quantization level values are obtained from an equation:
$$L = ⌊ \frac{x}{Qs} + f ⌋ ,$$
where, x is an original value, Qs is a quantization step, and f an offset value in the range of 0 to 1.

4. The method of claim 1, further comprising:
reducing histogram counts as much as a predetermined attenuation value if an accumulated count of the quantization level values exceeds a predetermined maximum accumulated value.

5. The method of claim 4, wherein the attenuation value is greater than or equal to zero and smaller than one.

6. The method of claim 5, wherein the accumulated count is one of a number of coefficients of one video frame, a number of coefficients of one slice, and a number of coefficients of one macroblock.

7. The method of claim 1, wherein the estimation of the distribution function is performed by interpolating the histogram counts using at least one of linear interpolation, bi-linear interpolation, and bi-cubic interpolation.

8. The method of claim 1, wherein the estimating the distribution function of the original values comprises:
estimating the histogram counts at a boundary position of a level section belonging to the quantization level values; and
interpolating the distribution function in the level section by the estimated histogram counts.

9. The method of claim 8, wherein the estimating the histogram counts is performed by obtaining an average of the histogram counts for two quantization level values adjacent to the boundary position.

10. The method of claim 8, wherein the interpolating the distribution function comprises obtaining two neighboring bar graphs having heights that are a result of multiplying the histogram counts for two quantization level values adjacent to the boundary position by weight values.

11. The method of claim 10, wherein the weight values are determined in consideration of distances between the histogram counts for the two quantization level values and the boundary position.

12. The method of claim 1, wherein the obtaining the restored values comprised obtaining a point halving an area occupied by the distribution function within a level section of the quantization level values.

13. The method of claim 1, wherein the updating the histogram, the estimating a distribution function and the obtaining the restored values are performed on a direct current (DC) component of the discrete cosine transform (DCT) coefficient and an alternating current (AC) component of the DCT coefficient, respectively, if the original values are a result of quantizing a DCT coefficient.

14. A dequantization apparatus for obtaining restored values for original values, the dequantization apparatus comprising:
a histogram update unit which updates a histogram by accumulating histogram counts for quantization level values;
a boundary-value estimation unit which estimates a distribution function of the original values based on the histogram; and
an output-value estimation unit which obtains the restored values for the quantization level values from the distribution function.

15. The dequantization apparatus of claim 14, wherein the quantization levels are generated when the original values are quantized.

16. The dequantization apparatus of claim 14, wherein the quantization level values are obtained from an equation:
$$L = ⌊ \frac{x}{Qs} + f ⌋ ,$$
wherein, x is an original value, Qs is a quantization step, and f is an offset value in a range of 0 to 1.

17. The dequantization apparatus of claim 16, further comprising a decrease-factor application unit which reduces histogram counts as much as a predetermined attenuation value if an accumulated count of the quantization level values exceeds a predetermined maximum accumulated value.

18. The dequantization apparatus of claim 17, wherein the attenuation value is greater than or equal to zero and smaller than one.

19. The dequantization apparatus of claim 17, wherein the accumulated count is one of a number of coefficients of one video frame, a number of coefficients of one slice, and a number of coefficients of one macroblock.

20. The dequantization apparatus of claim 16, wherein the estimation of the distribution function is performed by interpolating the histogram counts using at least one of linear interpolation, bi-linear interpolation, and bi-cubic interpolation.

21. The dequantization apparatus of claim 16, wherein the boundary-value estimation unit further estimates the histogram counts at a boundary position of a level section belonging to the quantization level values, and interpolates the distribution function in the level section by the estimated histogram counts.

22. The dequantization apparatus of claim 21, wherein the histogram update unit performs the histogram count estimation by taking an average of the histogram counts for two quantization level values adjacent to the boundary position.

23. The dequantization apparatus of claim 21, wherein the means for interpolating the distribution function obtains two neighboring bar graphs having heights that are a result of multiplying the histogram counts for two quantization level values adjacent to the boundary position by weight values, respectively.

24. The dequantization apparatus of claim 23, wherein the weight values are determined in consideration of distances between the histogram counts for the two quantization level values and the boundary position.

25. The dequantization apparatus of claim 16, wherein the means for obtaining the restored values obtains a point halving an area occupied by the distribution function within a level section of the quantization level values.

26. A video decoding method comprising:
performing lossless decoding on an input bitstream, and extracting texture data and motion vectors from the decoded bitstream;
estimating a distribution function based on a histogram updated by quantization level values constituting the extracted texture data;
obtaining restored values for the quantization level values from the estimated distribution function;
restoring a residual frame by performing an inverse spatial transform on the restored values;
generating a predicted frame by performing motion compensation on a pre-restored reference frame using the motion vectors; and
restoring a current frame by adding the restored residual frame to the predicted frame.

27. A video decoder comprising:
an entropy decoding unit that performs lossless decoding on an input bitstream and extracts texture data and motion vectors from the decoded bitstream;
a dequantization unit that estimates a distribution function based on a histogram updated by quantization level values constituting the extracted texture data, and obtains at least one of restored values and the quantization level values from the estimated distribution function;
an inverse spatial transform unit that restores a residual frame by performing an inverse spatial transform on the restored values;
a motion compensating unit that generates a predicted frame by performing motion compensation on a pre-restored reference frame using the motion vectors; and
an adder adds the restored residual frame to the prediction frame to restore a current frame.
